(19) United States
(12) Patent Application Publication
(10) Pub. No.: US 2021/0108389 A1
(43) Pub. Date: Apr. 15, 2021

(54) METHOD OF STRENGTHENING AND WIDENING SUBGRADE WITH GEOCELL BASED ON CONDUCTIVE POLYMER

(71) Applicant: INSTITUTE OF ROCK AND SOIL MECHANICS, CHINESE ACADEMY OF SCIENCES, Wuhan (CN)

(72) Inventors: Zheng LU, Wuhan (CN); Jie TIAN, Wuhan (CN); Hailin YAO, Wuhan (CN); Hong TANG, Wuhan (CN)

(73) Assignee: INSTITUTE OF ROCK AND SOIL MECHANICS, CHINESE ACADEMY OF SCIENCES, Wuhan (CN)

(21) Appl. No.: 16/748,133

(22) Filed: Jan. 21, 2020

(30) Foreign Application Priority Data
Oct. 15, 2019 (CN) 201910979508.3

(51) Int. Cl. E02D 17/18; E02D 17/20; E01C 3/00; E01C 3/04; C08L 23/06; C08K 3/04; C08K 7/06

(52) U.S. Cl. CPC E02D 17/18; E02D 17/202; E01C 3/003; E01C 3/04; C08L 23/06; E02D 2600/30; C08K 7/06; E02D 2300/0084; E02D 2300/0009; E02D 2200/17; C08L 2207/062; C08K 3/041

(57) ABSTRACT

The invention discloses a method for strengthening and widening subgrade with geocell based on conductive polymer, which belongs to the technical field of road construction. It includes the following steps: slope cutting and bench excavation for the existing embankment slope; leveling for the treated existing subgrade; filling and widening subgrade on the basis of the leveled existing subgrade; compacting the widened subgrade so that the compacted widened subgrade and the leveled existing subgrade are in the same plane; on the widened Subgrade The geocell based on the conductive polymer is tensioned and fixed for the first time; the geocell based on the conductive polymer is compacted to obtain the widened Subgrade of the geocell based on the conductive polymer. It can minimize the possibility of longitudinal cracks between the existing subgrade and the widened subgrade. In addition, it uses the conductivity of geocell based on conductive polymer to provide a material basis for monitoring the risk of cracks at the junction of the existing subgrade and the widened subgrade.

### TECHNICAL FIELD

The invention relates to the technical field of road construction, in particular to a geocell reinforcement and widening subgrade method based on conductive polymer.

### BACKGROUND TECHNOLOGY

The expressway built in the early part of last century was limited by many factors of economic development and construction technology at that time. At present, these roads have been unable to meet the increasing demand of transportation and social development because of the decline of transportation capacity caused by various road diseases. It is inevitable to widen the existing highway. In the old road widening project, because the settlement of the old road subgrade has been stable for many years, almost no deformation occurs, while the settlement time of the new road subgrade is short, consolidation produces new settlement, and the joint of the new and old subgrade will produce uneven settlement. If it goes beyond a certain range, it will produce longitudinal cracks, resulting in the pavement breaking under the load, which has a great impact on the driving quality.

### SUMMARY OF THE INVENTION

In view of this, the invention provides a geocell reinforcement widening subgrade method based on conductive polymer, which can minimize the possibility of longitudinal cracks between the existing subgrade and the widening subgrade, thereby improving the driving quality, and thus more suitable for practical use.

In order to achieve the first purpose, the technical scheme of the geocell reinforcement and widening subgrade method based on the conductive polymer is as follows:

The geocell reinforcement and widening subgrade method based on conductive polymer includes the following steps:

According to the slope cutting and bench excavation of the existing embankment, the treated existing subgrade is obtained;

The treated existing subgrade is leveled to obtain the leveled existing subgrade;

Filling and widening the subgrade on the basis of the leveled existing subgrade;

The widened subgrade is compacted so that the compacted widened subgrade and the leveled existing subgrade are in the same plane, and the widened subgrade is obtained;

A geocell based on conductive polymer is tensioned on the widened subgrade and fixed for the first time;

The geocell based on the conductive polymer is compacted to obtain the widened Subgrade of the geocell based on the conductive polymer.

The geocell reinforcement and widening subgrade method based on the conductive polymer provided by the invention can be further realized by adopting the following technical measures.

As a preferred method, to determine whether the widening subgrade of geocell based on conductive polymer has the risk of cracking at the junction of Existing Subgrade and widening subgrade, the following steps are included:

Detecting the actual resistance value of the geocell based on the conductive polymer;

According to the actual resistance value of the geocell based on the conductive polymer, the standard resistance value of the geocell based on the conductive polymer is calculated, wherein the relationship between the actual resistance value of the geocell based on the conductive polymer and the standard resistance value of the geocell based on the conductive polymer is

$$\frac{Ω}{{Ω}_{0}} = A {ɛ}^{2} + B ɛ + C \qquad ( 1 )$$

Where, Ω₀ is the standard resistance value of geocell based on conductive polymer, Ω is the actual resistance value of geocell based on conductive polymer, ε is the tensile strain value of conductive polymer, and A, B and C are coefficients;

According to the ratio between the standard resistance value of the geocell based on the conductive polymer and the allowable resistance value of the geocell based on the conductive polymer, a safety factor is obtained;

According to the safety factor, it is judged whether the widening subgrade of geocell based on conductive polymer has the risk of cracking at the junction of Existing Subgrade and widening subgrade.

As a preferred method, the method for obtaining the standard resistance value Ω₀ of geocell based on conductive polymer includes the following steps:

For the same conductive polymer, a set of equations including at least three equations based on the relationship (1) is constructed, wherein, Ω₀ is the standard resistance value of the geocell based on the conductive polymer, Ω is the actual resistance value of the geocell based on the conductive polymer, ε is the known tensile strain value of the conductive polymer, and coefficients A, B and C are unknown;

Solving the system of equations including at least 3 equations to obtain the values of coefficients A, B and C for the same conducting polymer;

The values of the coefficients A, B and C for the same conducting polymer are brought into the relationship (1), and the tensile strain values and coefficients A, B and C of the ε—conducting polymer are all known relationships (1);

According to the actual measured resistance value of the geocell based on the conductive polymer, the standard resistance value Ω₀ of the geocell based on the conductive polymer is calculated.

As a preferred method,

The base material of the geocell based on the conductive polymer is high-density polyethylene,

The conductive polymer is selected from one or several composite materials of carbon black, carbon fiber and carbon nanotube.

As a preferred method, according to the safety factor, it is determined whether the widening subgrade of geocell based on conductive polymer has the risk of cracking at the junction of Existing Subgrade and widening subgrade, specifically including:

When the safety factor is more than 1, the widening subgrade of geocell based on conductive polymer has the risk of cracking at the junction of Existing Subgrade and widening subgrade;

When the safety factor is less than or equal to 1, there is no risk of cracking at the junction of the existing subgrade and the widened subgrade.

As a preferred method, the slope cutting method is selected from equal slope cutting method or variable slope cutting method.

As a preferred method, the step excavation processing method is selected from the bottom-up excavation method or the top-down excavation method.

As a preferred method, when the widening subgrade is compacted, the difference between the compaction height of the widening subgrade and the leveling height of the existing subgrade is ≤3 cm-5 cm.

As a preferred method, the first fixing is fixed by U-shaped steel pin.

As a preferred method, compaction of the geocell based on the conductive polymer to obtain the widened Subgrade of the geocell based on the conductive polymer specifically includes the following steps:

Filling the geocell reinforced layer based on the conductive polymer after the initial fixation, the value range of the filler particle size used for the filling is 3 mm-6 mm, so that the height of the filler exceeds 120 mm-200 mm of the top surface of the geocell based on the conductive polymer, and the geocell after the filling based on the conductive polymer is obtained;

Manually tamping the filled geocell based on the conductive polymer, so that the tensile state and shape of the geocell based on the conductive polymer are maintained during the filling process, and a manually tamped geocell based on the conductive polymer is obtained;

The mechanical filling paving is carried out for the artificially compacted geocell based on the conductive polymer, and the widened Subgrade of the geocell based on the conductive polymer is obtained.

The geocell reinforcement and widening subgrade method based on conductive polymer provided by the invention first carries out slope cutting and bench excavation for the existing embankment slope to obtain the treated existing subgrade; then carries out leveling for the treated Existing Subgrade to obtain the leveled existing subgrade; then fills the widened subgrade on the basis of the leveled Existing Subgrade; then compacts and expands the subgrade The wide subgrade makes the compacted widened subgrade and the leveled Existing Subgrade in the same plane, so that the widened subgrade can be obtained; then, on the widened subgrade, the geocell based on conductive polymer is tensioned and laid and fixed for the first time; finally, the geocell based on conductive polymer is compacted to obtain the widened subgrade based on conductive polymer. It can strengthen the joint strength of new and old subgrade by geocell, and reduce the uneven settlement between new and old subgrade. It can reduce the possibility of the longitudinal crack between the existing subgrade and the widened subgrade to the maximum extent, so as to improve the driving quality.

### DESCRIPTION OF DRAWINGS

By reading the detailed description of the preferred embodiments below, various other advantages and benefits will become clear to those skilled in the art. The drawings are for the purpose of showing preferred embodiments only and are not considered to be a limitation of the invention. And in the whole drawing, the same parts are represented by the same reference symbols. In the attached figure:

FIG. 1 Schematic diagram of geocell based on conductive polymer in strengthening and widening subgrade structure;

FIG. 2 Schematic diagram of detection method of geocell slice;

FIG. 3 Schematic diagram of spreading and laying of geogrid;

FIG. 4 is a flow chart of the steps of the geocell reinforcement and widening subgrade method based on the conductive polymer provided by the embodiment of the invention;

FIG. 5 is a flow chart of the method steps provided by the embodiment of the invention to determine whether the widening subgrade of the geocell based on the conductive polymer has the risk of cracking at the junction of the existing subgrade and the widening subgrade;

FIG. 6 is a step flow chart of a method for obtaining the standard resistance value Ω₀ of a geocell based on a conductive polymer provided by an embodiment of the invention;

FIG. 7 is a flow chart of the steps for compacting the geocell based on conductive polymer applied in the geocell based on conductive polymer reinforcement and widening subgrade method provided by the embodiment of the invention to obtain the widening subgrade of the geocell based on conductive polymer;

Among them, 1. Existing subgrade, 2. Widening subgrade, 3. Geocell, 4. Monitoring wire, 5. Ohmmeter, 6. Monitoring terminal.

### SPECIFIC IMPLEMENTATION MODE

In order to solve the problems existing in the prior art, the invention provides a geocell reinforcement and widening subgrade method based on conductive polymer, which can minimize the possibility of generating longitudinal cracks between the existing subgrade and the widening subgrade, thereby improving the driving quality and being more suitable for practical use.

In order to further elaborate the technical means and efficacy adopted by the invention to achieve the predetermined invention purpose, the following is a detailed description of the specific implementation mode, structure, features and efficacy of the geocell reinforcement and widening subgrade method based on the conductive polymer according to the invention in combination with the attached drawings and preferred embodiments. In the following description, different “one embodiment” or “Embodiments” do not necessarily refer to the same embodiment. In addition, the features, structures, or features in one or more embodiments may be combined by any suitable form.

In this paper, the term “and/or” is just a kind of association relation describing the associated object, which means that there can be three kinds of relations, for example, a and/or B. specifically, it can be understood as: it can contain a and B at the same time, it can exist a alone or B alone, and it can have any of the above three situations.

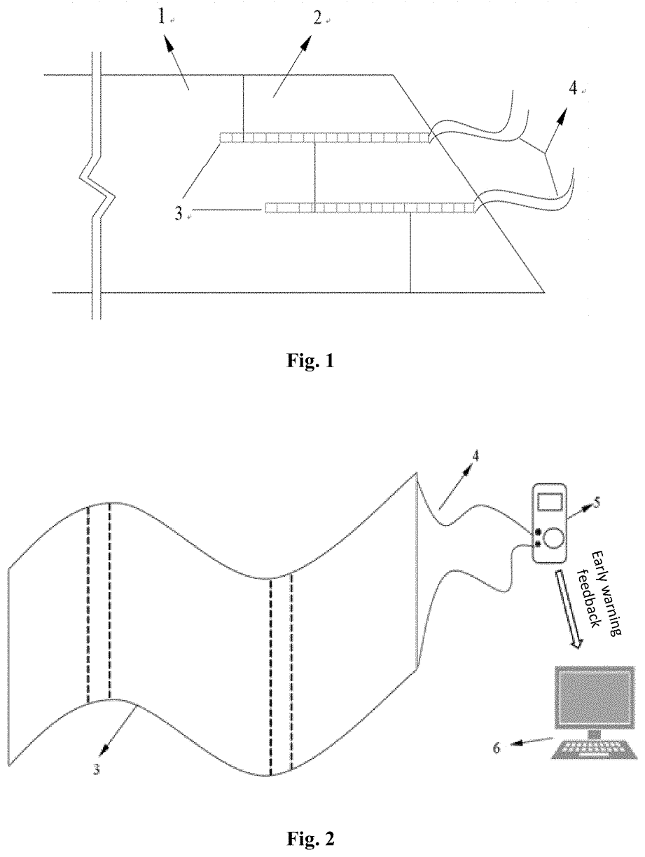

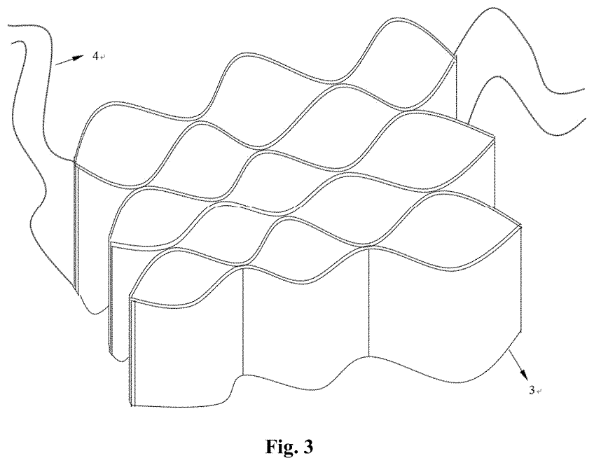

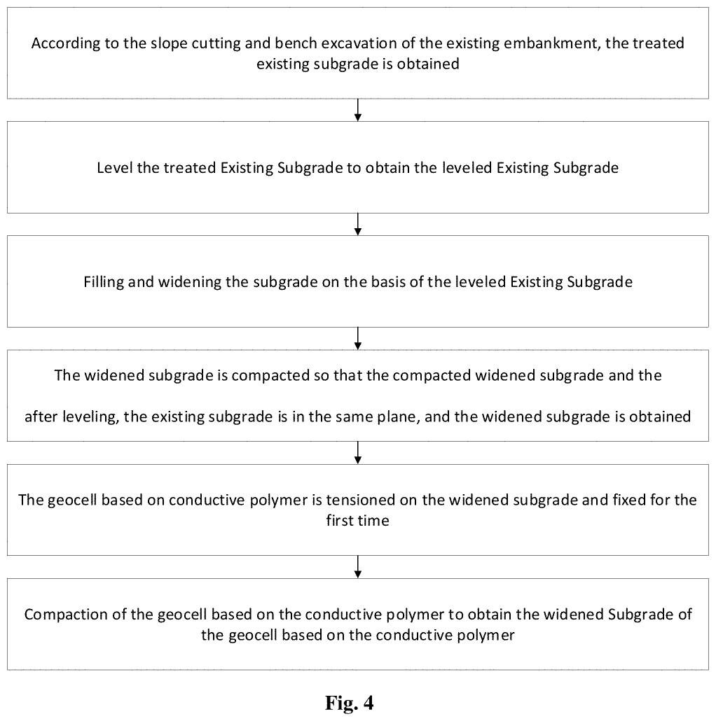

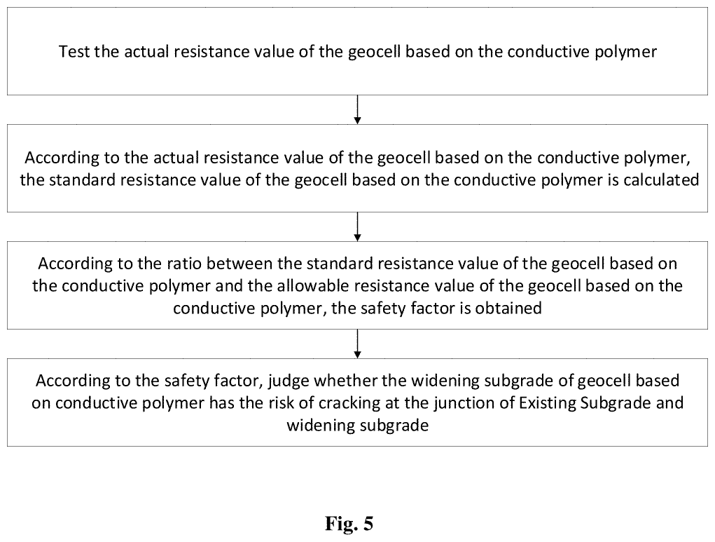

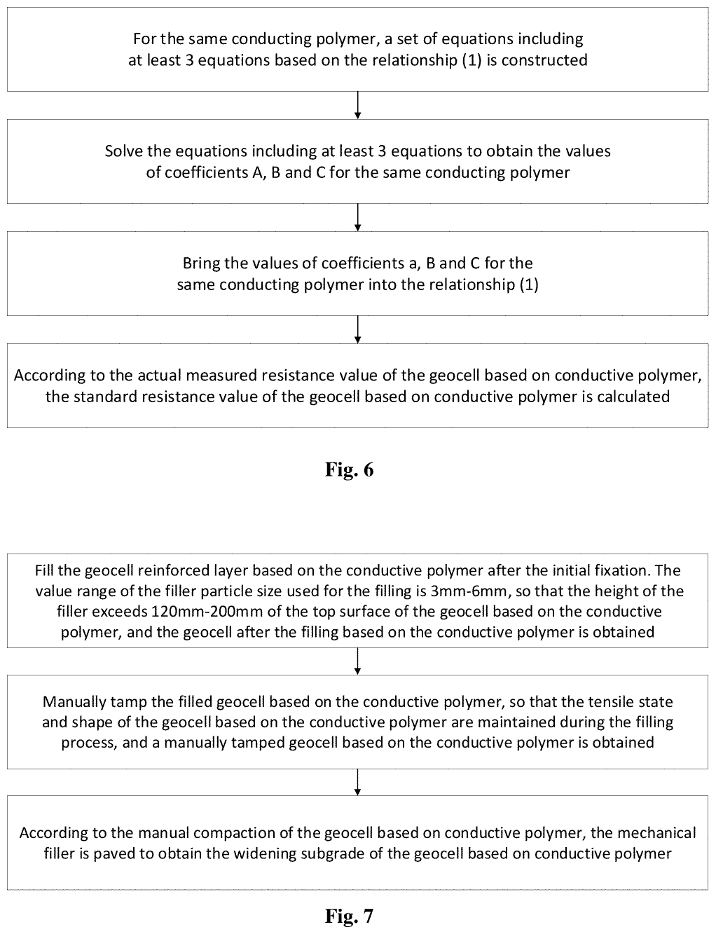

With reference to FIGS. 1 to 4, the geocell reinforcement and widening subgrade method based on conductive polymer provided by the embodiment of the invention includes the following steps:

Step S101: carry out slope cutting and bench excavation for the existing embankment slope to obtain the treated existing subgrade;

Step S102: level the treated Existing Subgrade to obtain the leveled existing subgrade;

Step S103: fill and widen the subgrade on the basis of the leveled existing subgrade;

Step S104: compact the widened subgrade so that the compacted widened subgrade and the leveled existing subgrade are in the same plane, and the widened subgrade is obtained;

Step S105: the geocell based on conductive polymer is tensioned on the widened subgrade and fixed for the first time;

Step S106: compact the geocell based on conductive polymer to obtain the widened Subgrade of geocell based on conductive polymer.

The geocell reinforcement and widening subgrade method based on conductive polymer provided by the invention first carries out slope cutting and bench excavation for the existing embankment slope to obtain the treated existing subgrade; then carries out leveling for the treated Existing Subgrade to obtain the leveled existing subgrade; then fills the widened subgrade on the basis of the leveled Existing Subgrade; then compacts and expands the subgrade The wide subgrade makes the compacted widened subgrade and the leveled Existing Subgrade in the same plane, so that the widened subgrade can be obtained; then, on the widened subgrade, the geocell based on conductive polymer is tensioned and laid and fixed for the first time; finally, the geocell based on conductive polymer is compacted to obtain the widened subgrade based on conductive polymer. It can strengthen the joint strength of new and old subgrade by geocell, and reduce the uneven settlement between new and old subgrade. It can reduce the possibility of the longitudinal crack between the existing subgrade and the widened subgrade to the maximum extent, so as to improve the driving quality.

Wherein, the method to determine whether the widening subgrade of geocell based on conductive polymer has the risk of cracking at the junction of Existing Subgrade and widening subgrade includes the following steps:

Step S201: detect the actual resistance value of geocell based on conductive polymer;

Step S202: according to the actual resistance value of geocell based on conductive polymer, calculate the standard resistance value of geocell based on conductive polymer, wherein, the relationship between the actual resistance value of geocell based on conductive polymer and the standard resistance value of geocell based on conductive polymer is

$$\frac{Ω}{{Ω}_{0}} = A {ɛ}^{2} + B ɛ + C \qquad ( 1 )$$

Where, Ω₀ is the standard resistance value of geocell based on conductive polymer, Ω is the actual resistance value of geocell based on conductive polymer, c is the tensile strain value of conductive polymer, and A, B and C are coefficients;

Step S203: according to the ratio between the standard resistance value of the geocell based on the conductive polymer and the allowable resistance value of the geocell based on the conductive polymer, the safety factor is obtained;

Step S204: according to the safety factor, judge whether the widening subgrade of geocell based on conductive polymer has the risk of cracking at the junction of Existing Subgrade and widening subgrade.

In this case, once the risk of cracking at the junction of the existing subgrade and the widened subgrade is judged, an alarm will be given, and the alarm information will also provide the specific geographical location of the risk of cracking at the junction of the existing subgrade and the widened subgrade, so that the maintenance personnel can timely eliminate the risk.

The method for obtaining the standard resistance value of geocell based on conductive polymer includes the following steps:

Step S301: for the same conductive polymer, a set of equations including at least three equations based on relation (1) is constructed, wherein, Ω₀ is the standard resistance value of the geocell based on the conductive polymer, Ω is the actual resistance value of the geocell based on the conductive polymer, ε is the known tensile strain value of the conductive polymer, and coefficients A, B and C are unknown;

Step S302: solve the equations including at least three equations to obtain the values of coefficients A, B and C for the same conducting polymer;

Step S303: the values of coefficients A, B and C for the same conducting polymer are brought into the relationship (1), and the tensile strain values and coefficients A, B and C of ε-conducting polymer are all known relationships (1);

Step S304: according to the actual measured resistance value of geocell based on conductive polymer, the standard resistance value Ω₀ of geocell based on conductive polymer is calculated.

In this embodiment, when the constructed equation system based on relation (1) includes three equations, the values of coefficients A, B and C can be obtained by direct solution. When the equation group based on relation (1) consists of more than three equations, the coefficients A, B and C can be obtained by the least square method. Among them, the more number of equations included in the equation group based on relation (1), the more accurate the values of coefficient A, B and C can be obtained.

Wherein, the base material of geocell based on conductive polymer is high-density polyethylene, and conductive polymer is selected from one or several composite materials of carbon black, carbon fiber and carbon nanotubes.

According to the safety factor, the risk of cracking at the junction of the existing subgrade and the widened Subgrade of the geocell based on the conductive polymer is determined, including:

When the safety factor is more than 1, the widening subgrade based on conducting polymer geocell has the risk of cracking at the junction of Existing Subgrade and widening subgrade;

When the safety factor is less than or equal to 1, there is no risk of cracking at the junction of the existing subgrade and the widened subgrade.

Wherein, the slope cutting method is selected from equal slope cutting method or variable slope cutting method.

Wherein, the method of bench excavation is selected from bottom-up excavation or top-down excavation.

Wherein, the difference between the compaction height of the widened subgrade and the leveling height of the existing subgrade shall be no more than 3 cm-5 cm.

Wherein, U-shaped steel bolt is used for the first fixing.

Wherein, compaction of geocell based on conductive polymer to obtain the widening subgrade of geocell based on conductive polymer specifically includes the following steps:

Step S401: fill the reinforced layer of geocell based on conductive polymer which has been fixed for the first time. The value range of filler particle size used for filling is 3 mm-6 mm, so that the height of filler is 120 mm-200 mm higher than the top surface of geocell based on conductive polymer, and the filled geocell based on conductive polymer is obtained;

Step S402: conduct manual compaction for the filled geocell based on conductive polymer, so that the tensile state and shape of the geocell based on conductive polymer are maintained during the filling process, and the geocell based on conductive polymer is obtained through manual compaction;

Step S403: pave the mechanical filler for the artificially compacted geocell based on conductive polymer to obtain the widening subgrade of the geocell based on conductive polymer.

### Implementation Example

Step 1: the geocell is made of high density polyethylene (HDPE) as the base material, and conductive polymer is added in the production process to make conductive composite material, so that the geocell has conductive function.

Step 2: carry out the preliminary test on the geocell sheet with conductive function to determine the tensile strength of the geocell sheet and the relationship between the deformation of the composite material and the change of resistance, as an important change rule of using resistance to reflect the deformation of the geocell sheet. To determine the relationship between the deformation of polymer cell sheet and the change of resistance, the following formula can be obtained:

$$\frac{Ω}{{Ω}_{0}} = A {ɛ}^{2} + B ɛ + C$$

Wherein, Ω₀ is the standard resistance value of the polymer, Ω is the actual resistance value of the polymer, c is the tensile strain value of the conductive polymer, and A, B and C are coefficients.

Step 3: in order to make the new and old embankments closely connected and reduce the differential settlement of consolidation of the new and old embankments, it is generally necessary to cut the slopes of the old embankments and excavate the steps, which can remove the soil with insufficient compaction of the surface layer of the old embankment slope at a certain depth, improve the contact area between the new filling part and the old embankment at the joint, increase the friction resistance and shear resistance of the joint part, and be able to work in the abutment Geocell is set on the step.

According to the soil mass of the slope and the foundation under the slope, the method of equal slope cutting can be adopted, that is, the slope can be cut along the same width of the old road slope without changing the slope of the old road slope; the method of variable slope cutting can also be adopted, that is, the slope of the cut slope is greater than the slope of the old road slope. When the slope cutting is steep, it is easy to cause the collapse of the old subgrade. The method of gradual slope cutting can be used for many times. Each slope cutting is used for partial foundation treatment, and then the slope cutting is carried out to ensure the stability of the old road slope. The method of variable slope cutting is adopted, i.e. the original embankment slope of 1:1.5 is cut by 1:0.5 and 1:1.0 respectively.

Generally, the excavation of slope steps shall be carried out after slope cutting. There are two main methods of bench excavation: one is bottom-up excavation, which is currently used in most expressways; the other is top-down excavation. The first method is divided into two kinds: one is to excavate all steps and then fill the widened subgrade; the other is to excavate and fill at the same time, that is to say, after the widened subgrade is filled to the first step, the second step is dug.

In this example, the old road slope is excavated into steps with a height of 100 cm and a width of 150 cm. The method of excavating from bottom to top and then filling the new subgrade or excavating and filling at the same time is adopted. After the step excavation, the excavation surface is cleaned first, the loose soil on the surface is removed, the surface of the step is leveled and compacted manually. After the old subgrade is leveled, the new subgrade shall be filled to slightly higher than the old subgrade, and the new subgrade shall be compacted first, with the compaction height no more than 3-5 mm from the old subgrade. The geocell based on conductive polymer is tensioned to the widened subgrade to ensure that the cell is fully tensioned. Each cell has the same size and regular shape, and is initially fixed with U-shaped steel bolt.

Step 4: check whether the sheet of geocell is complete. If any damage or fracture is found, handle it in time. The outer side of the line embankment led out by the geocell plays an early warning role in the process of detection and operation. If there is no bad problem in geocell, it can be filled. When filling the reinforced layer of geocell, attention shall be paid to ensure that the geocell is fully tensioned and completed within one day. The particle size of the filling material shall not be too large and shall be controlled at about 3-6 mm. The filling method of the reinforced layer of the lattice shall be manual filling to ensure that the filling material inside the lattice is relatively uniform, and at the same time to eliminate the large deformation of the inclination that may occur during the filling process of the lattice. When the filling is completed, the height of the filling material shall be about 150 mm higher than the top height of the lattice. Then carry out manual compaction. During the compaction process, try to keep the tensile state of geocell and the shape of the cell. After the filling of this layer is basically completed, manual compaction can be changed into mechanical spreading of large area filling.

Step 5: before rolling, the flatness and moisture content of the filling layer shall be checked, and rolling can only be carried out after meeting the requirements. Bulldozer shall be used for initial leveling, and then grader shall be used for paving and leveling according to the layer thickness. In the process of compaction, the vibratory roller is used, and the static pressure leveling without vibration is carried out once at first, and it is slow first and then fast, from weak vibration to strong vibration.

Step 6: after the first geocell reinforcement layer is filled and compacted, first check whether the compactness of the subgrade meets the construction requirements. If it does not meet the requirements, carry out supplementary compaction until it meets the compactness requirements. If the compactness meets the requirements, carry out the next process, connect the lead from step 4 with the megger, and check whether the conductivity function of the geocell is normal.

Step 7: repeat steps 3 to 6 above when filling the second layer and laying the lattice.

The embodiment also relates to a monitoring method for uneven settlement of new and old subgrade and a safety early warning mechanism. The geocell based on conducting polymer has the function of conducting electricity. Through the relationship between the resistivity and the deformation of the geocell, the deformation of geocell is fed back in real time according to the change of the resistivity of geocell. According to the important change rule of geocell deformation reflected by the resistance measured in the laboratory, a deformation threshold value is set as the maximum resistance value Ωₘₐₓ corresponding to the dislocation deformation of the new and old subgrade, which is the allowable resistance value of the conductive polymer geocell. The safety factor is as follows:

$$k = \frac{{Ω}_{0}}{{Ω}_{max}}$$

If k>1, that is, the actual resistance value of conductive polymer is higher than the allowable resistance value of geocell polymer, that is, the strain value of geocell is greater than the allowable maximum strain, then the road surface has a risk of cracking, otherwise, the road surface has no risk of cracking. The specific operation steps are as follows:

Connect the outer end of the reserved conductor in step 4 with the megger, and record the initial resistance value. When the settlement and deformation of the subgrade cause the deformation of the geocell, the geocell will be deformed by the external force, which makes its own resistance change significantly. By detecting the resistance change between different positions on the geocell, the deformation of the geocell and the position of the deformation will be confirmed, and the deformation of the new and old subgrade will be further confirmed Judgment is used to predict the risk degree of widening pavement cracking. On this basis, do a good job in maintenance and repair of widened pavement.

The geocell based on conductive polymer can improve the strength of the geocell sheet, strengthen the reinforcement effect of the geocell on widening the subgrade structure, and reduce the uneven settlement between the new and old subgrade; on the other hand, the geocell with conductive polymer has a certain degree of strength The function of geocell is to reflect the deformation of geocell under the upper load by measuring the resistance change of geocell in the working process. When the deformation of geocell exceeds the allowable deformation value, the road surface is in danger of cracking.

According to the preliminary test of the geocell sheet based on conductive polymer, the tensile strength of the geocell sheet and the relationship between the deformation of composite material and the change of resistance are measured as the important change rule of the geocell sheet deformation reflected by the resistance. The relationship between the resistivity of the material and the length and area of the material is formula 2:

$$ρ = \frac{RS}{L}$$

Where ρ is the resistivity, L is the length of the material, S is the area, and R is the resistance value. Resistivity has nothing to do with the length and cross-sectional area of the conductor material. It belongs to the electrical property of the material itself, which is determined by the conductor material. However, it is not difficult to see from the above formula that the resistance of the material is directly proportional to the length of the material, that is, the longer the length is, the greater the resistance of the material is; and it is inversely proportional to the cross-sectional area of the material, that is, the cross-sectional area is, when the material and the length are not changed The larger the area, the smaller the resistance.

After the geocell is laid, check whether the compactness meets the requirements, and connect the reserved wire into the ohmmeter to observe whether the reading is normal and whether the functionality is complete. By using this kind of special geocell, we can monitor the deformation of new and old roadbed. After the completion of the construction, first measure the post construction resistance of the geocell, which is recorded as the initial resistance a According to Formula 1, the initial deformation value of the geocell can be obtained; when the measured actual resistance value exceeds the threshold value Ωₘₐₓ, at this time, the strain value of the safety factor k>1 cell is greater than the allowable maximum strain, then the road surface is in danger of cracking, which will give an early warning to the terminal, because the splicing section is in progress Reinforcement treatment shall be carried out to prevent potential safety hazards.

The above geocell based on conductive polymer can strengthen the connection strength of the new and old subgrade joints and reduce the uneven settlement between the new and old subgrade. At the same time, it can also monitor the change of resistance in the geocell in real time, and then monitor the deformation of the geocell. When the deformation is larger than the allowable maximum strain, it will end It can repair the large deformation area and avoid the occurrence of potential safety hazards. This scheme has important innovative value and engineering significance in subgrade widening project, and has broad application prospects, which is conducive to promotion and application.

Although preferred embodiments of the invention have been described, those skilled in the art may make additional changes and modifications to these embodiments once they have learned the basic inventive concepts. Therefore, the appended claims are intended to be interpreted to include preferred embodiments and all changes and modifications falling within the scope of the invention.

Obviously, those skilled in the art can make various changes and modifications to the invention without departing from the spirit and scope of the invention. In this way, if these modifications and variations of the invention fall within the scope of the claims of the invention and its equivalent technology, the invention also intends to include these modifications and variations.

1. A geocell reinforcement and widening subgrade method based on conductive polymer, which is characterized by the following steps:
According to the slope cutting and bench excavation of the existing embankment, the treated existing subgrade is obtained;
The treated existing subgrade is leveled to obtain the leveled existing subgrade;
Filling and widening the subgrade on the basis of the leveled existing subgrade;
The widened subgrade is compacted so that the compacted widened subgrade and the leveled existing subgrade are in the same plane, and the widened subgrade is obtained;
A geocell based on conductive polymer is tensioned on the widened subgrade and fixed for the first time;
The geocell based on the conductive polymer is compacted to obtain the widened Subgrade of the geocell based on the conductive polymer.

2. The method for strengthening and widening subgrade with geocell based on conductive polymer according to claim 1, which is characterized in that the method for judging whether the widened subgrade with geocell based on conductive polymer has the risk of cracking at the junction of Existing Subgrade and widened subgrade includes the following steps:
Detecting the actual resistance value of the geocell based on the conductive polymer;
According to the actual resistance value of the geocell based on the conductive polymer, the standard resistance value of the geocell based on the conductive polymer is calculated, wherein the relationship between the actual resistance value of the geocell based on the conductive polymer and the standard resistance value of the geocell based on the conductive polymer is
$$\frac{Ω}{{Ω}_{0}} = A {ɛ}^{2} + B ɛ + C \qquad ( 1 )$$
Wherein, Ω₀ is the standard resistance value of geocell based on conductive polymer, Ω is the actual resistance value of geocell based on conductive polymer, c is the tensile strain value of conductive polymer, A, B and C are coefficients;
According to the ratio between the standard resistance value of the geocell based on the conductive polymer and the allowable resistance value of the geocell based on the conductive polymer, a safety factor is obtained;
According to the safety factor, it is judged whether the widening subgrade of geocell based on conductive polymer has the risk of cracking at the junction of Existing Subgrade and widening subgrade.

3. The geocell reinforcement and widening subgrade method based on the conductive polymer according to claim 2, which is characterized in that the method for obtaining the standard resistance value Ω₀ of the geocell based on the conductive polymer comprises the following steps:
For the same conductive polymer, a set of equations including at least three equations based on the relationship (1) is constructed, wherein, Ω₀ is the standard resistance value of the geocell based on the conductive polymer, Ω is the actual resistance value of the geocell based on the conductive polymer, ε is the known tensile strain value of the conductive polymer, and coefficients A, B and C are unknown;
Solving the system of equations including at least 3 equations to obtain the values of coefficients A, B and C for the same conducting polymer;
The values of the coefficients A, B and C for the same conducting polymer are brought into the relationship (1), and the tensile strain values and coefficients A, B and C of the ε-conducting polymer are all known relationships (1);
According to the actual measured resistance value of the geocell based on the conductive polymer, the standard resistance value of the geocell based on the conductive polymer is calculated.

4. The geocell reinforcement and widening subgrade method based on conductive polymer according to claim 2, which is characterized in that,
The base material of the geocell based on the conductive polymer is high-density polyethylene,
The conductive polymer is selected from one or several composite materials of carbon black, carbon fiber and carbon nanotube.

5. The method for strengthening and widening the subgrade based on the conductive polymer geocell according to claim 2, which is characterized in that, according to the safety factor, it is determined whether the widened subgrade based on the conductive polymer geocell has the risk of cracking at the junction of the existing subgrade and the widened subgrade, specifically including:
When the safety factor is more than 1, the widening subgrade of geocell based on conductive polymer has the risk of cracking at the junction of Existing Subgrade and widening subgrade;
When the safety factor is less than or equal to 1, there is no risk of cracking at the junction of the existing subgrade and the widened subgrade.

6. The geocell reinforcement and widening subgrade method based on conductive polymer according to claim 1, which is characterized in that the slope cutting method is selected from equal slope cutting method or variable slope cutting method.

7. The geocell reinforcement and widening subgrade method based on conductive polymer according to claim 1, which is characterized in that the step excavation treatment method is selected from the bottom-up excavation method or the top-down excavation method.

8. The geocell reinforcement widening subgrade method based on conductive polymer according to claim 1, which is characterized in that when the widening subgrade is compacted, the difference between the compaction height of the widening subgrade and the leveling height of the existing subgrade is ≤3 cm-5 cm.

9. The geocell reinforcement and widening subgrade method based on conductive polymer according to claim 1, which is characterized in that the first fixing is fixed by U-shaped steel bolt.

10. The method for strengthening and widening the subgrade based on the conductive polymer geocell according to claim 1, which is characterized in that, by compacting the geocell based on the conductive polymer, the widened subgrade based on the conductive polymer geocell specifically includes the following steps:
Filling the geocell reinforced layer based on the conductive polymer after the initial fixation, the value range of the filler particle size used for the filling is 3 mm-6 mm, so that the height of the filler exceeds 120 mm-200 mm of the top surface of the geocell based on the conductive polymer, and the geocell after the filling based on the conductive polymer is obtained;
Manually tamping the filled geocell based on the conductive polymer, so that the tensile state and shape of the geocell based on the conductive polymer are maintained during the filling process, and a manually tamped geocell based on the conductive polymer is obtained;
The mechanical filling paving is carried out for the artificially compacted geocell based on the conductive polymer, and the widened Subgrade of the geocell based on the conductive polymer is obtained.
